(19) United States
(12) Patent Application Publication
(10) Pub. No.: US 2007/0101439 A1
(43) Pub. Date: May 3, 2007

(54) System and method for authorizing business information access

(76) Inventors: Oliver G. Strauch, Schwetzingen (DE); Ralph K. Kiefer, Bous (DE)

Correspondence Address: KENYON & KENYON LLP, 1500 K STREET N.W., WASHINGTON, DC, 20005, US

(21) Appl. No.: 11/250,562

(22) Filed: Oct. 17, 2005

(51) Int. Cl. H04L 9/32; H04L 9/00; G06F 17/30; H04K 1/00; G06F 7/04; G06K 9/00; H03M 1/68; H04N 7/16

(52) U.S. Cl. 726/28; 713/165; 713/167; 713/182

(57) ABSTRACT

A system and method for authorizing business information access. According to an embodiment, an application receives criteria for modeling a type of user to access business information, generates a group of users based on the criteria, and authorize access to the business information by the group of users. According to another embodiment, a data structure comprises one or more data elements identifying users, one or more data elements grouping the identified users based on specified criteria about business information to be accessed, and one or more data elements linking the group of identified users with the business information. An example of the present invention includes authorizing a channel partner to access and receive campaign information about a brand owner's products.

### BACKGROUND OF THE INVENTION

Product manufacturers and service providers, known as “brand owners,” work with many independently operating external business partners, known as “channel partners,” who market, sell, and/or service the brand owners' products. To have successful relationships with channel partners, a brand owner must be able to share information about the owner's products with its channel partners so that the partners may operate effectively on behalf of the brand owner.

For example, brand owners consider it very important to convey the current information about the brand owners' products to their channel partners. This includes campaign-related information about the brand owner's products, such as details about a soon-to-be released new product, upgrades of existing products, on-sale products, special promotions, etc. The campaign information may also include a description of the consumer group to whom the brand owner wants to target the campaign and the duration of the campaign. Having such campaign information helps the channel partner effectively direct its activities on behalf of the brand owner to the target consumer group.

Because brand owners consider campaign information to be highly sensitive, ensuring its security is important. Brand owners provide campaign information to only those channel partners eligible for such campaigns or for whom the information would be most relevant, while not providing the information to all other partners. Brand owners typically conduct several campaigns at once. As such, ensuring that the correct campaign information is provided to the correct channel partner is a nontrivial task.

Customer relationship management (CRM) solutions (such as mySAP CRM) are computer applications that allow brand owners to manage their channel partners by providing access to data and processes on the brand owner's CRM system, so that the channel partners may readily access product information. For those channel partners, a “partner portal” provides a user interface through which channel partners access the brand owner's CRM system from an external computer network.

However, in CRM systems, it has not been possible to designate certain partners to have access to certain campaign information. Because of this, brand owners have not been able to (a) model groups of authorized channel partners and (b) securely set up and maintain the authorizations.

There is a need in the art for a system and method for authorizing business information access.

### BRIEF DESCRIPTION OF THE DRAWINGS

FIG. 1A is a system diagram in accordance with an embodiment of the present invention.

FIG. 1B is a block diagram that depicts software components resident on a management server in accordance with an embodiment of the present invention.

FIGS. 2A through 2C are block diagrams that depict data structures associated with partner authorization groups in accordance with an embodiment of the present invention.

FIG. 3 is a flowchart of a method for creating partner authorization groups in accordance with an embodiment of the present invention.

FIG. 4 is a screenshot that depicts a segment builder screen as viewed by a brand owner from which the brand owner may create partner authorization groups made up of channel partners in accordance with an embodiment of the present invention.

FIG. 5 is a screenshot that depicts a marketing planner screen as viewed by a brand owner from which the brand owner may create a campaign and designate it as accessible to partner authorization groups in accordance with an embodiment of the present invention.

FIG. 6 is a screenshot that depicts a marketing planner screen as viewed by a brand owner from which the brand owner may link partner authorization groups to a campaign in accordance with an embodiment of the present invention.

FIG. 7 is a flowchart of a method for authorizing access to a campaign for channel partners belonging to the designated partner authorization group in accordance with an embodiment of the present invention.

FIG. 8 is a screenshot that depicts a campaign screen as viewed by a channel partner that shows the campaign that the channel partner is authorized to access in accordance with an embodiment of the present invention.

FIG. 9 is a block diagram that depicts a computing device in accordance with an embodiment of the present invention.

### DETAILED DESCRIPTION

The present invention increases the capabilities of customer relationship management applications by authorizing access by channel partners to relevant campaigns and associated information of a brand owner. The present invention does this by adding access functionality to an existing CRM application and applying this functionality to channel partner data.

In a CRM application, each business object such as an activity, a lead, an opportunity, etc., is assigned to a particular channel partner, thereby granting that partner access to the information associated with these objects. For example, channel partner A is assigned to handle lead X. Hence, channel partner A (but no other channel partners) is granted access to information regarding lead X by virtue of being assigned thereto. In an example of a CRM system, a tool called “sales partner” assigns a channel partner to a business object. A rule generator, e.g., an access control engine (ACE), then generates an access rule, which is executed when the partner logs into the CRM system to authorize access by the channel partner named by the “sales partner” tool to the business object information. The rule generator further allows access by one or more employee of the assigned channel partner.

In the case of campaigns, each campaign is typically assigned to multiple channel partners, rather than to a single one. While the above assignment idea is extendible to campaigns as business objects, the above-described tool would assign channel partners to campaigns, one partner at a time. This would be a time-consuming, laborious process for the brand owner. Therefore, a further extension of this idea to allow multiple channel partners to be assigned to a campaign, all at once, has been implemented in the present invention, which will be described below.

In a CRM system, campaign information has generally been set up for distribution to end customers, i.e., the purchasers of the brand owner's product, but not to channel partners. The end customers, however, receive campaign information from the brand owner, but can not access the brand owner's system for the information. In an example of a CRM system, a brand owner uses a tool called “marketing planner” to create a campaign, which includes information about the new campaign to be launched. A brand owner uses a tool called “segment builder” to set up a “market segment”, which defines the type of customer to whom a campaign should be targeted. The brand owner inputs descriptive criteria about the target customer into the segment builder, which builds the market segment containing the criteria. The builder tool then generates the target group of end customers that meets those criteria to receive the campaign information. The marketing planner tool then links the target group with the campaign. The system sends all or portions of the campaign information to the end customers, in a broadcast email, for example. This operation of the CRM system is known.

The present invention extends this CRM application to meet the needs of channel management to define groups of channel partners to which campaign information should be distributed and adds functionality to authorize the channel partners to access the brand owner's CRM system to get the campaign information. In an example of a CRM system, the segment builder may be modified to define channel partner groups called partner authorization groups (PAGs). As with target groups of end customers, the brand owner may define a PAG of channel partners by inputting descriptive criteria about channel partners to whom the campaign information should be directed. Examples of descriptive criteria may include, but are not limited to, a partner type, a partner program, a partner status, duration of partner's relationship with brand owner, etc. For example, a partner type may be an “authorized dealer,” a partner program may refer to a “platinum partner,” a partner's status may be “active,” and duration of partner's relationship with brand owner may be “since 2003.”

Suppose a brand owner wishes to send campaign information about the latest widgets to all channel partners who are active, authorized dealers of the brand owner's widgets. As such, the brand owner inputs “active” and “authorized dealer of widgets” as desired criteria of channel partners forming a PAG for this campaign. The segment builder then generates a PAG containing the channel partners who meet the criteria. The marketing planner designates a new campaign as accessible to PAGs, links the campaign to particular PAGs, and triggers the access control engine to generate access rules. The access control engine then generates access rules that authorize the PAG partners to access the campaign information on the brand owner's CRM system. It is possible to assign one or more PAGs to a campaign.

Alternatively, the brand owner may select particular channel partners to make up a PAG. The segment builder generates the PAG containing the selected channel partners. The marketing planner links the PAG to a campaign and triggers the access control engine. The access control engine then generates the access rules that authorize the PAG partners to access the campaign information.

This extended functionality allows the brand owner to assign multiple channel partners to a campaign all at once, thereby saving time and effort. Moreover, the brand owner may assign the channel partners to campaigns in the same way as the brand owner has assigned end customers to campaigns. Hence, the brand owner need not learn new tools. Additionally, the use of existing applications minimizes the developer's time and effort in adding this functionality.

When a channel partner logs onto the brand owner's CRM system, the access control engine executes the access rules that authorize the logged-in partner to access campaign information. The channel partner can access the designated campaign information, but not other campaign information. If a channel partner is not in a PAG associated with certain campaign information, the channel partner can not access the information at all.

Authorizing a channel partner to access campaign information on the brand owner's CRM system advantageously provides the channel partner with real-time information about the featured product, additional information that is not accessible in broadcast emails, individual channel partner information regarding the campaign, the partner's role in the campaign, e.g., individual sales targets, etc.

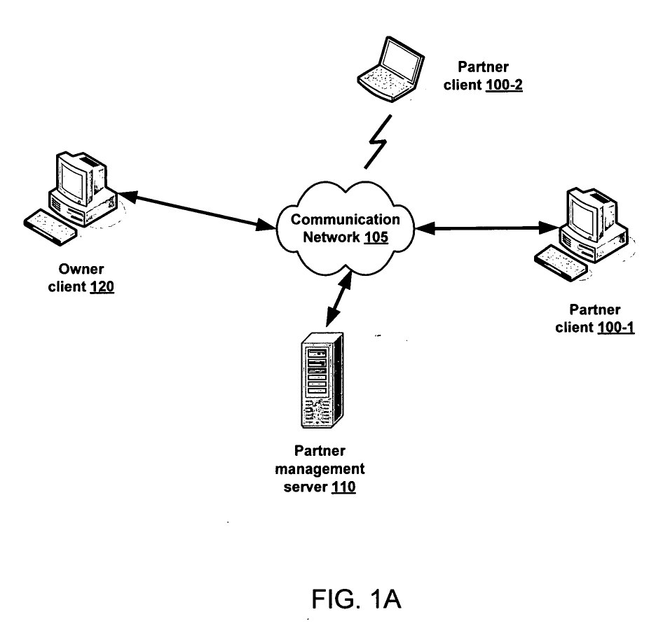

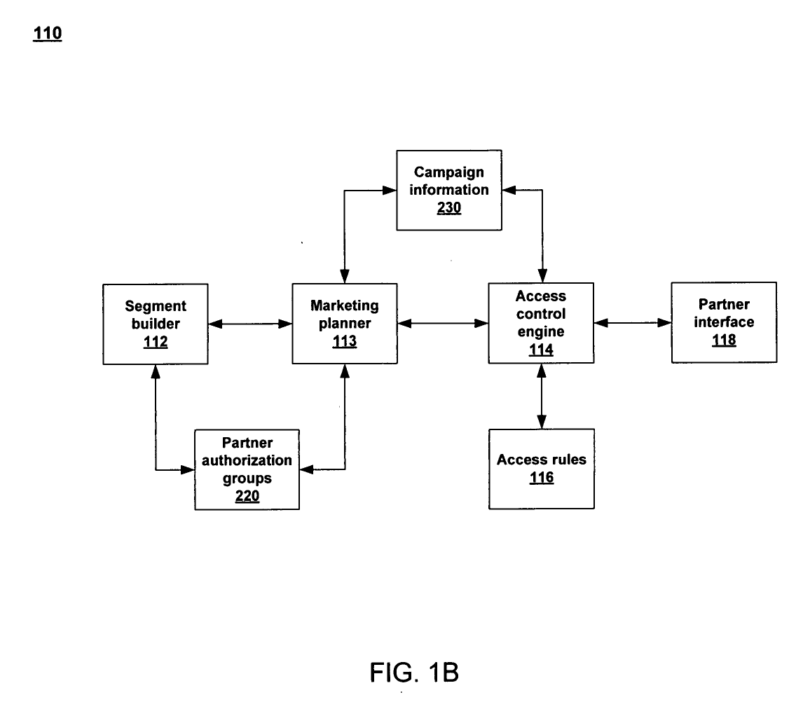

FIG. 1A is a diagram of a system for authorizing business information access in accordance with an embodiment of the present invention. In this embodiment, a channel partner may utilize partner client 100-1 or 100-2 to access campaign information on partner management server 110, which is operated by a brand owner. The brand owner may utilize owner client 120 to set up PAGs on partner management server 110. Server 110 may execute the applications to generate the PAGs from the brand owner's input, generate the access rules from the PAGs, and then authorize access by PAG partners to particular campaign information based on the access rules. Partner clients 100-1 and 100-2, owner client 120, and partner management server 110 may be connected via communication network 105.

It is to be understood that the system is not limited to that illustrated in FIG. 1A, but may include any client devices, server devices, and transmission media capable of providing embodiments of the present invention.

FIG. 1B is a block diagram that depicts software components that may reside on a management server in accordance with an embodiment of the present invention. Server 110 may include segment builder 112, which may receive descriptive criteria from the brand owner about the type of channel partner that should be authorized to access particular campaign information. Segment builder 112 may then search the channel partner information to find partners who match the criteria. Alternatively, segment builder 112 may receive a list of channel partners authorized to access the campaign information. Segment builder 112 may then generate partner authorization groups 220, including the determined channel partners.

Server 110 may also include marketing planner 113, which may receive campaign information from the brand owner and store campaign information 230 on server 110. Marketing planner 113 may link partner authorization groups 220 with corresponding campaign information 230. Linking provides access to all campaign information associated with the linked campaign, including subordinate campaign elements. Alternatively, marketing planner 113 may link partner authorization groups to particular campaign elements. Marketing planner 113 may also send some campaign information 230 out to partner authorization groups 220 via broadcast emails, for example.

Server 110 may also include access control engine 114, which may be triggered by marketing planner 113 to generate access rules 116. Access control engine 114 may then generate access rules 116 based on the linked campaign information 230 and partner authorization groups 220. Access control engine 114 may then store access rules 116 on server 110.

Access control engine 114 may act as a gatekeeper when a channel partner logs into the brand owner's CRM system. Upon notification of a partner's login, access control engine 114 may execute access rules 116 in which the logged-in partner is a member of a PAG. Access control engine 114 may then allow access to campaign information 230, as defined in the executed access rule.

Server 110 may also include a partner interface 118 through which a channel partner may log onto the brand owner's system and view campaign information 230.

In addition to campaign information 230, server 110 may also handle other types of marketing related information, e.g., trade promotions and deals, according to embodiments of the present invention.

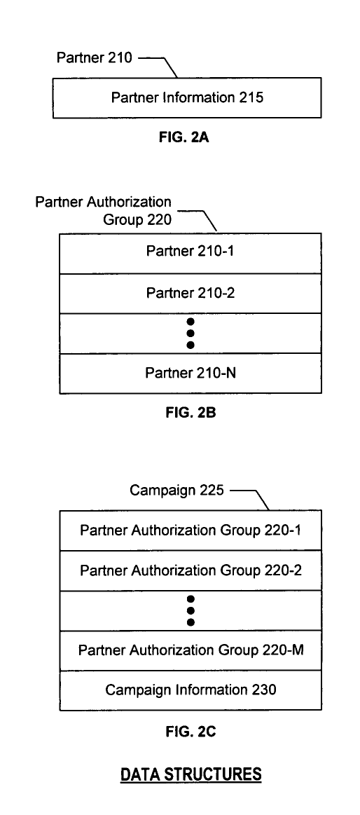

FIGS. 2A-2C depict data structures that may be utilized in the implementation of partner authorization groups in accordance with an embodiment of the present invention. FIG. 2A illustrates a partner data structure (data structure 210), which may include partner information (data structure 215) that identifies the channel partner, e.g., the company name, address, telephone number, email address, employees, etc.

FIG. 2B illustrates a partner authorization group data structure (data structure 220), which may include partner data structures (210) of those channel partners to be assigned to one or more campaigns.

FIG. 2C illustrates a campaign data structure (data structure 225), which may include campaign information (data structure 230) that includes the name of the campaign, the target product, the time period of the campaign, etc. The campaign data structure (225) may also include PAG data structures (220), which identify the partners who are authorized to access campaign information represented by campaign data structure (225).

It is to be understood that the representation of the data is not limited to the data structures described herein, but may include any representation capable of storing and retrieving data.

A brand owner may input partner information (215) to server 110, which may store the partner information (215) into a database in partner (210). The brand owner may also input campaign information (230), which may be stored in the database in campaign (225). When the brand owner inputs partner descriptive criteria to server 110, the segment builder 112 may take the descriptive criteria and search partner information (215) for channel partners meeting the criteria. The segment builder 112 may then generate partner authorization group (220) with pointers to the group's partners (210). Marketing planner 113 may include pointers in campaign (225) to the generated partner authorization groups (220).

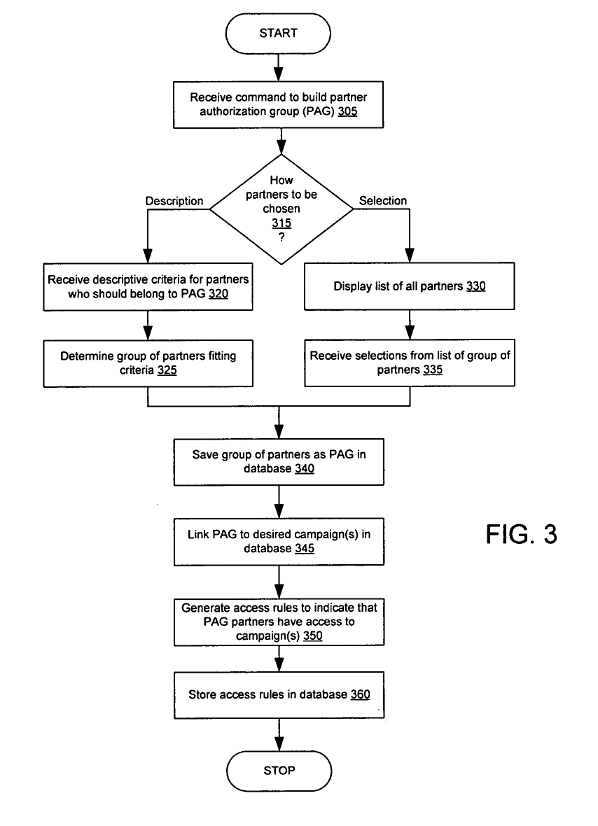

FIG. 3 is a flowchart of a method for creating partner authorization groups in accordance with an embodiment of the present invention. In this embodiment, server 110 may receive (305) a command to build a partner authorization group (PAG) from owner client 120. Server 110 may inquire (315) whether the channel partners to make up the PAG are chosen by description or by selection.

If the PAG is formed by description, server 110 may receive (320) descriptive criteria about the type of channel partner who should receive campaign information from owner client 120. Server 110 may determine (325) the channel partners who meet the criteria and then group the determined partners into a PAG.

If the PAG is formed by selection, server 110 may display (330) a list of all the brand owner's channel partners in the database on owner client 120. Server 110 may receive (335) the brand owner's selections on the list from owner client 120 and then group the selected partners into a PAG.

Server 110 may save (340) the PAG in the database. Server 110 may link (345) the PAG to one or more campaign stored in the database.

Server 110 may then execute a rule generator, e.g., the access control engine, and generate (350) access rules to indicate that the PAG partners are authorized to access campaign information. For example, partners X, Y, and Z form a PAG that has been authorized by a brand owner to access campaign A. Server 110 may generate the following access rule: Access to “Campaign A” if “Partner X” or “Partner Y” or “Partner Z.”

Server 110 may also authorize access to one or more employees of the channel partners that form the PAG. For example, any employee of partners X, Y, and Z that form a PAG has been authorized by a brand owner to access campaign A. Server 110 may generate the following access rule: Access to “Campaign A” if “employee of Partner X” or “employee of Partner Y” or “employee of Partner Z.” The partner information stored in the database would include an employee list of each partner to be read by the access rule upon authorizing access to the campaign information.

Server 110 may store (360) the generated access rules in its database for later use to authorize channel partner access.

Because the present invention extends an existing application to provide PAG functionality, the existing functions may also be used with the new PAGs. For example, the PAGs may be used as target groups for the brand owner to broadcast emails informing the PAG partners of a new campaign.

Similarly, the PAG functionality may be applied to other marketing related information, e.g., trade promotions and deals.

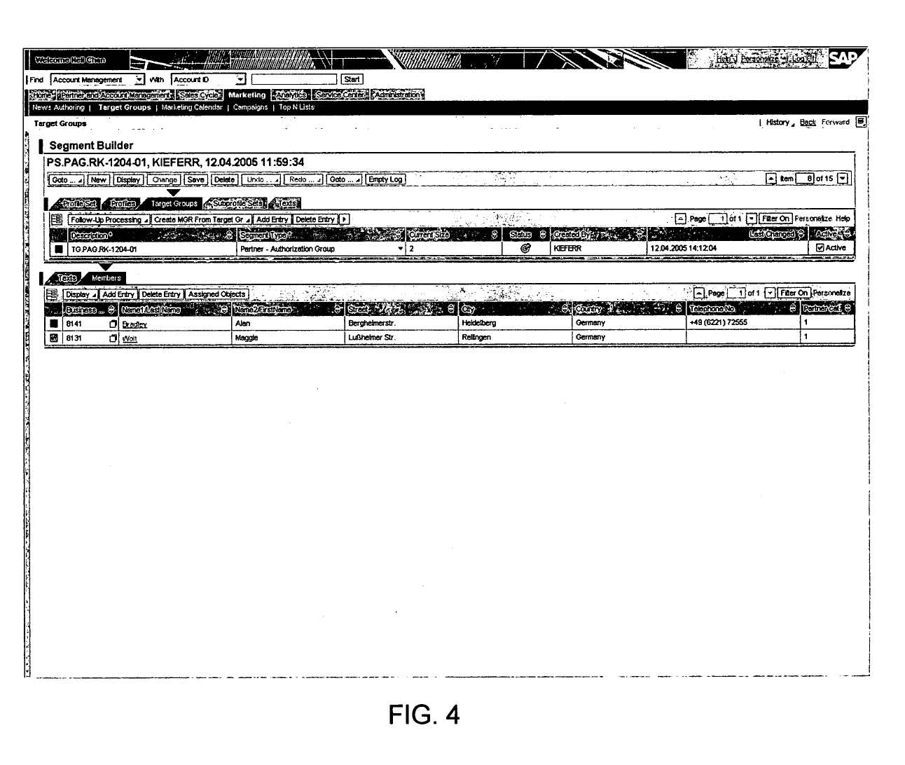

FIG. 4 is a screenshot that depicts a segment builder screen as viewed by a brand owner from which the brand owner may create PAGs made up of channel partners in accordance with an embodiment of the present invention. The brand owner may create a PAG using the segment builder tool. In this screen, the brand owner creates the PAG by selecting particular channel partners to form the PAG. The brand owner selects the “Target Groups” tab to create a PAG. The brand owner then selects the “Members” tab to include channel partners in the PAG. To add partners to the PAG, the brand owner selects “Add Entry.” To remove partners from the PAG, the brand owner selects “Delete Entry.”

Alternatively, in FIG. 4, the brand owner may create the PAG by inputting descriptive criteria of the type of channel partner to receive the campaign information. To do so, the brand owner selects the “Profiles” tab and inputs the criteria. The segment builder then models the PAG containing channel partners who meet the criteria.

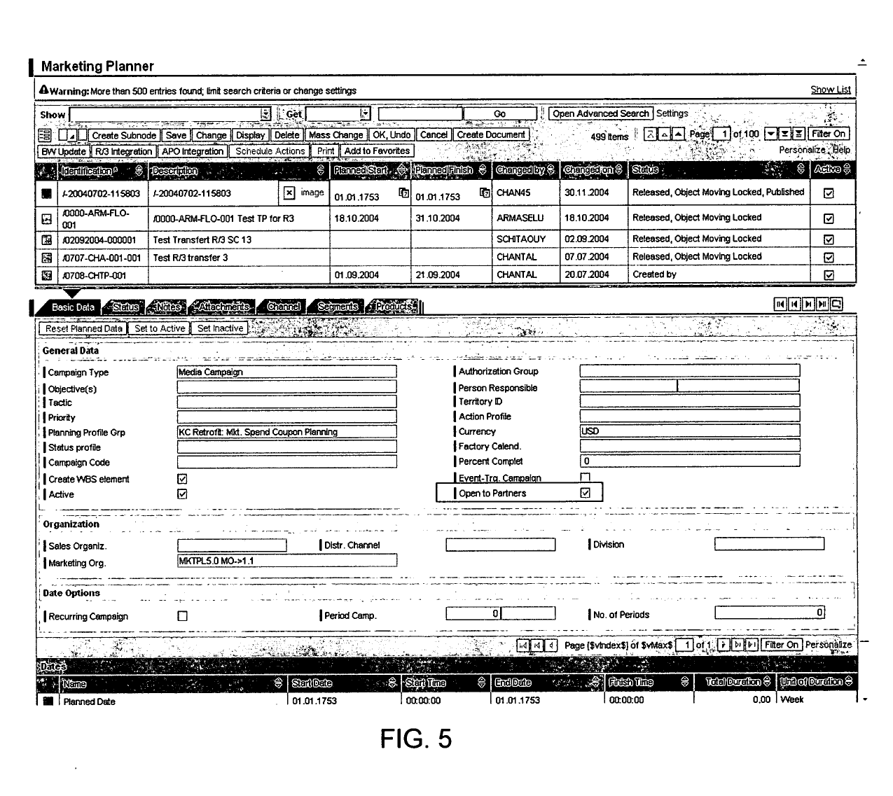

FIG. 5 is a screenshot that depicts a marketing planner screen as viewed by a brand owner from which the brand owner may create a campaign and designate it as accessible to PAGs in accordance with an embodiment of the present invention. The screen shows a listing of the current campaigns in the brand owner's system. To create a new campaign, the brand owner selects the “Create Subnode” button and inputs the required information regarding the campaign. Conversely, to delete a campaign, the brand owner selects the “Delete” button. The screen shows that campaign “/-20040702-115803” has been created by the brand owner. The brand owner selects the “Basic Data” tab to enter and review the campaign information associated with this campaign. To permit access to the campaign by channel partners, the brand owner checks the box “Open to Partners.”

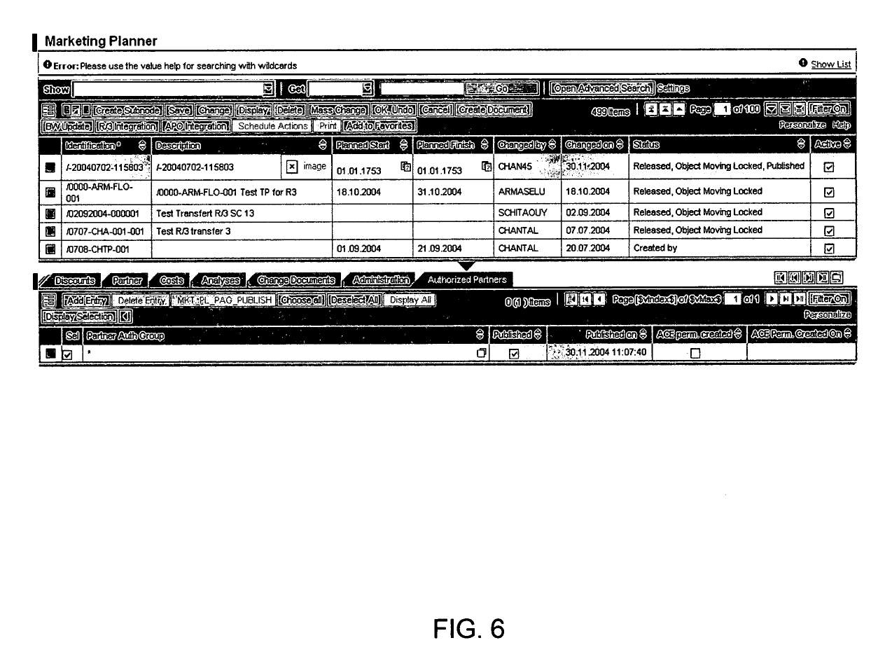

FIG. 6 is a screenshot that depicts a marketing planner screen as viewed by a brand owner in which the brand owner may link PAGs to a campaign in accordance with an embodiment of the present invention. The screen shows that campaign “/20040702-115803” has been selected by the brand owner. To link PAGs to this campaign, the brand owner selects the “Authorized Partners” tab and either enters the name of the PAG or selects the PAG from a search list using a function “value help.” The brand owner checks the “Published” box associated with the PAG, thereby triggering the creation of access rules by the access control engine.

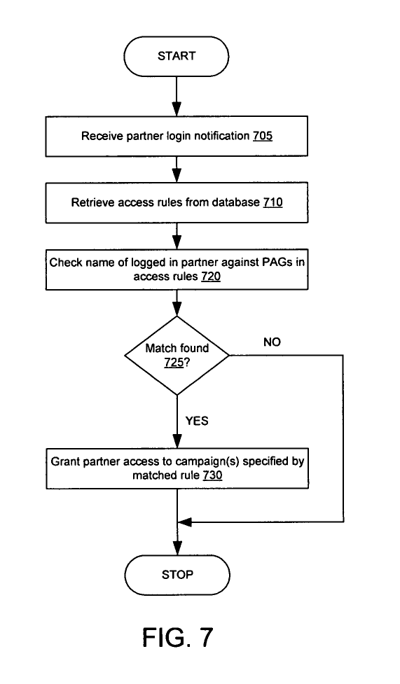

FIG. 7 is a flowchart of a method for authorizing access to a campaign for channel partners belonging to the designated PAG in accordance with an embodiment of the present invention. As a channel partner logs onto server 110 via partner client 100, server 110 may receive (705) a login notification. Server 110 may retrieve (710) the campaign access rules from its database. Server 110 may check (720) the name of the logged-in channel partner against the partners listed in the PAGs in the access rules.

If a match is found (725), server 110 may execute the matched access rule and grant (730) the logged-in partner access to the campaigns specified by the matched access rule. The channel partner may then review campaign information on the brand owner's CRM system. Server 110 may also check an employee list of a channel partner if the channel partner is listed in a PAG to determine whether the logged-in employee is listed as being authorized to access a campaign.

If a match is not found (725), server 110 may not allow the logged-in partner access to any campaign information, though the partner may view other business objects to which the partner has been assigned.

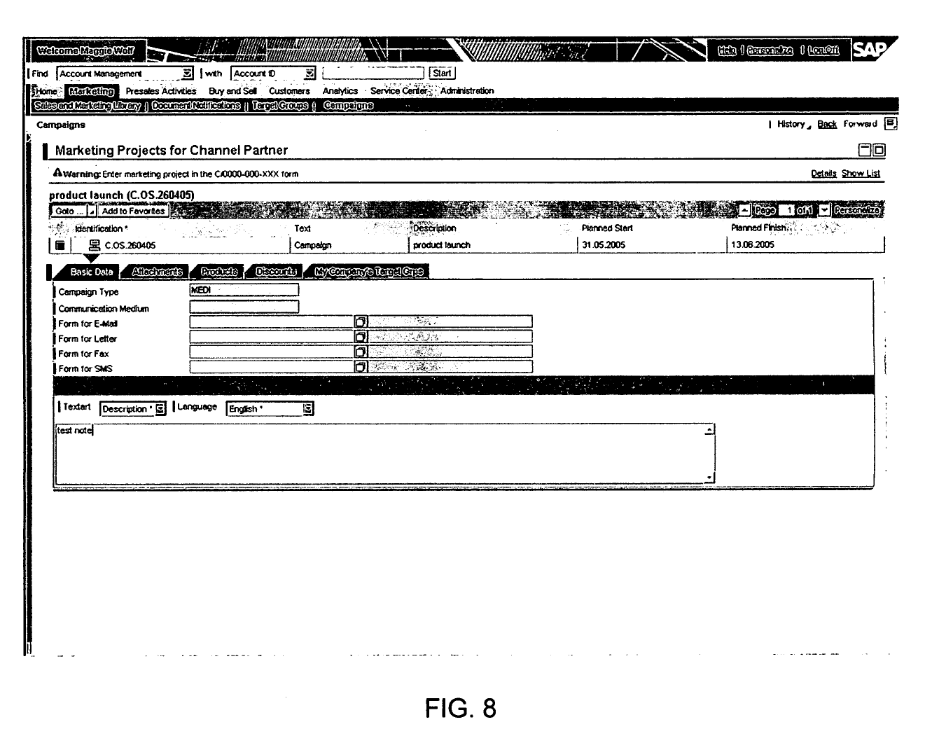

FIG. 8 is a screenshot that depicts a campaign screen as viewed by a channel partner that shows the campaign that the channel partner is authorized to access in accordance with an embodiment of the present invention. After logging onto the brand owner's system, the channel partner selects “Campaigns” to view the campaigns the channel partner is authorized to see. The partner then selects “Basic Data” to view the campaign information.

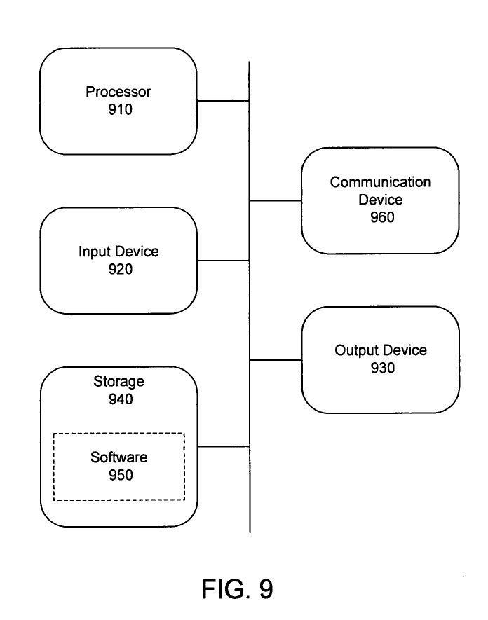

FIG. 9 illustrates the components of a basic computing device in accordance with an embodiment of the present invention, which may include partner client 100, partner management server 110, and owner client 120. The computing device may be a personal computer, workstation, handheld personal digital assistant (“PDA”), or any other type of microprocessor-based device. The computing device may include one or more of processor 910, input device 920, output device 930, storage 940, and communication device 960.

Input device 920 may include a keyboard, mouse, pen-operated touch screen or monitor, voice-recognition device, or any other device that provides input. Output device 930 may include a monitor, printer, disk drive, speakers, or any other device that provides output.

Storage 940 may include volatile and nonvolatile data storage, including one or more electrical, magnetic or optical memories such as a RAM, cache, hard drive, CD-ROM drive, tape drive or removable storage disk. Communication device 960 may include a modem, network interface card, or any other device capable of transmitting and receiving signals over a network. The components of the computing device may be connected via an electrical bus or wirelessly.

Software 950, which may be stored in storage 940 and executed by processor 910, may include, for example, the application programming that embodies the functionality of the present invention (e.g., as embodied in mySAP CRM 5.0). Software 950 may include a combination of enterprise servers such as an application server and a database server.

Communication network 105 may include any type of interconnected communication system, which may implement any communications protocol, which may be secured by any security protocol. The corresponding network links may include telephone lines, DSL, cable networks, T1 or T3 lines, wireless network connections, or any other arrangement that implements the transmission and reception of network signals.

The computing device may implement any operating system, such as Windows or UNIX. Software 950 may be written in any programming language, such as ABAP, C, C++, lava or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention. For example, the data structures that implement the present invention can take many different forms yet still provide the same functionality.

What is claimed is:

1. A computer-implemented method for authorizing access to business information, comprising:
receiving criteria for modeling a type of user to access business information;
generating a group of users based on the criteria; and
authorizing access to the business information by the group of users.

2. The method of claim 1, wherein the generating comprises:
searching information about each user that matches the criteria;
selecting a user whose information matches at least one of the criteria; and
grouping the selected users.

3. The method of claim 1, wherein the authorizing comprises:
associating the group of users with the business information; and
generating an access rule defining the association.

4. The method of claim 3, further comprising:
upon receipt of a user login notification, executing the access rule to determine whether the user is authorized to access the business information.

5. The method of claim 1, further comprising:
preventing access to the business information by users not in the group of users; and
limiting access by the group of users to only the business information.

6. The method of claim 1, further comprising:
receiving a selection of users from among all users; and
generating the group of users made up of the selected users.

7. The method of claim 1, further comprising:
authorizing one or more employees of the group of users to access the business information.

8. The method of claim 1, wherein a brand owner provides the criteria for modeling a type of channel partner, wherein the channel partner markets, sells, and/or services the brand owner's products.

9. The method of claim 8, wherein the business information is campaign information about the brand owner's products.

10. The method of claim 8, wherein the business information is trade promotions or deals regarding the brand owner's products.

11. A data structure to authorize access to business information, the data structure comprising:
one or more data elements identifying users;
one or more data elements grouping the identified users based on specified criteria about business information; and
one or more data elements linking the group of identified users with the business information to authorize access by the group to the business information.

12. A computer-implemented method for sending campaign information, comprising:
generating a list of channel partners to receive campaign information based on characteristics of the channel partners; and
broadcasting an email that includes the campaign information to the listed channel partners.

13. The method of claim 12, wherein the generating comprises:
defining the characteristics of the channel partners;
searching a database for channel partners who have at least one of the defined characteristics; and
generating the list of the channel partners who have the at least one characteristic.

14. The method of claim 12, wherein the broadcasting comprises:
retrieving from a database the email addresses of the listed channel partners; and
generating the email that includes the campaign information addressed to the retrieved email addresses; and
sending the email.

15. The method of claim 12, further comprising:
authorizing the list of channel partners to access a brand owner's system to get the campaign information.

16. A computer-implemented method for providing access to business information, comprising:
authorizing access by users to business information based on relevance of the business information to the user;
tailoring the business information to each authorized user; and
displaying the tailored business information to the users.

17. The method of claim 16, wherein the authorizing comprises:
receiving a description about the type of user to which the business information would be relevant;
grouping users who satisfy the description; and
authorizing access for the grouped users.

18. The method of claim 16, wherein the tailoring comprises:
retrieving from a database each authorized user's information that is related to the business information; and
modifying the business information to include the retrieved information.

19. The method of claim 18, wherein each authorized user's information includes projected sales of a product, new products in a product line, or pricing details of a product sold by the user that is featured in the business information.

20. The method of claim 16, further comprising:
displaying real-time business information to the users.
